(19) United States
(12) Patent Application Publication
(10) Pub. No.: US 2011/0016531 A1
(43) Pub. Date: Jan. 20, 2011

(54) SYSTEM AND METHOD FOR AUTOMATED MAINTENANCE BASED ON SECURITY LEVELS FOR DOCUMENT PROCESSING DEVICES

(76) Inventors: Michael Yeung, Mission Viejo, CA (US); Ashish Khandelwal, Aliso Viejo, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/504,048

(22) Filed: Jul. 16, 2009

(51) Int. Cl. G06F 11/36; G06F 9/44

(52) U.S. Cl. 726/25; 717/124

(57) ABSTRACT

The subject application is directed to a system and method for automated maintenance of preselected security levels for document processing devices. A network data connection is established with at least one document processing device of a plurality thereof. At least one document processing device is identified and testing software is pushed to the at least one document processing device so as to commence loading and running thereof. Test result data is received from the at least one document processing device in accordance with a running of the testing software, a security level associated with the at least one document processing device is identified, and updated software is pushed to the at least one document processing device in accordance with received test result data and an identified security level.

### BACKGROUND OF THE INVENTION

The subject application is directed generally to maintaining security levels of document processing devices. The application is particularly applicable to automated maintenance of security for each of a plurality of document processing devices in accordance with a security level appropriate for each device.

Document processing devices include copiers, printers, facsimile machines, scanners and e-mail devices. Devices which combine more than one of these functions are in common use, and are referred to as multifunction peripherals (MFPs) or multifunction devices (MFDs).

Modern document processing devices are extremely powerful business tools, and frequently run in connection with an integrated computer system, called a controller, to facilitate operation in connection with software-based controls. Given that controllers are software based, there is a continuing need to be assured that they are running a desired version or patch level of various software associated with operation thereof. The importance of running current or correct software is particularly essential to maintain security of devices. Some devices are in use or environments wherein security is raised to a higher level of concern. Such uses may be in connection with medical record environments, accounting environments, or in legal environments

### SUMMARY OF THE INVENTION

In accordance with one embodiment of the subject application, there is provided a system and method for automated maintenance of preselected security levels for document processing devices. A network data connection is established with at least one document processing device of a plurality thereof. At least one document processing device is identified and testing software is pushed to the at least one document processing device so as to commence loading and running thereof. Test result data is received from the at least one document processing device in accordance with a running of the testing software, a security level associated with the at least one document processing device is identified, and updated software is pushed to the at least one document processing device in accordance with received test result data and an identified security level.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for automated maintenance of preselected security levels for document processing devices according to one embodiment of the subject application;

FIG. 2 is a block diagram illustrating device hardware for use in the system for automated maintenance of preselected security levels for document processing devices according to one embodiment of the subject application;

FIG. 3 is a functional diagram illustrating the device for use in the system for automated maintenance of preselected security levels for document processing devices according to one embodiment of the subject application;

FIG. 4 is a block diagram illustrating controller hardware for use in the system for automated maintenance of preselected security levels for document processing devices according to one embodiment of the subject application;

FIG. 5 is a functional diagram illustrating the controller for use in the system for automated maintenance of preselected security levels for document processing devices according to one embodiment of the subject application;

FIG. 6 is a functional diagram illustrating a server for use in the system for automated maintenance of preselected security levels for document processing devices according to one embodiment of the subject application;

FIG. 7 is a block diagram illustrating the system for automated maintenance of preselected security levels for document processing devices according to one embodiment of the subject application;

FIG. 8 is a functional diagram illustrating the system for automated maintenance of preselected security levels for document processing devices according to one embodiment of the subject application;

FIG. 9 is a flowchart illustrating a method for automated maintenance of preselected security levels for document processing devices according to one embodiment of the subject application; and

FIG. 10 is a flowchart illustrating a method for automated maintenance of preselected security levels for document processing devices according to one embodiment of the subject application.

### DETAILED DESCRIPTION OF THE PREFERRED EMBODIMENT

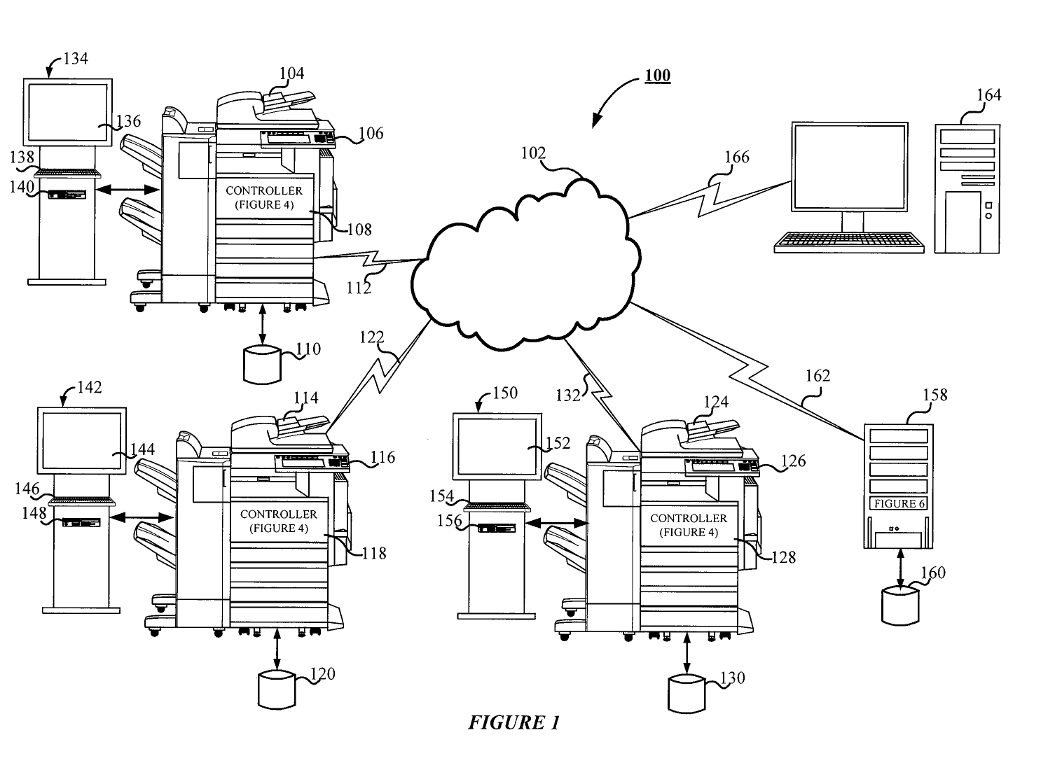

The subject application is directed to a system and method for updating security levels of document processing devices. In particular, the subject application is directed to a system and method for maintaining security levels of multiple document processing devices. More particularly, the subject application is directed to a system and method that is applicable to automated maintenance of security for each of a plurality of document processing devices in accordance with a security level appropriate for each device. It will become apparent to those skilled in the art that the system and method described herein are suitably adapted to a plurality of varying electronic fields employing security management, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for automated maintenance of preselected security levels for document processing devices in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also one or more document rendering devices, depicted in FIG. 1 as the document rendering devices 104, 114, and 124. As shown in FIG. 1, the document rendering devices 104, 114, and 124 are illustrated as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document rendering devices include, for example and without limitation, the Toshiba e-Studio Series Controller. In accordance with one aspect of the subject application, the document rendering devices 104, 114, and 124 are suitably adapted to provide remote document processing services to external or network devices. According to one embodiment of the subject application, the document rendering devices 104, 114, and 124 include hardware, software, and any suitable combination thereof, configured to interact with an associated user, a networked device, or the like. Preferably, the document processing devices 104, 114, and 124 are capable of implementing various security protocols, levels, and the like, based upon settings configured by an associated user, administrator, manufacturer, or the like.

According to one embodiment of the subject application, the document rendering devices 104, 114, and 124 are suitably equipped to receive a plurality of portable storage media, including, without limitation, Firewire drive, USB drive, SD, MMC, XD, Compact Flash, Memory Stick, and the like. In the preferred embodiment of the subject application, the document rendering devices 104, 114, and 124 further include associated user interfaces 106, 116, and 126, such as a touch-screen, LCD display, touch-panel, alpha-numeric keypad, or the like, via which an associated user is able to interact directly with the document rendering devices 104, 114, and 124. In accordance with the preferred embodiment of the subject application, the user interfaces 106, 116, and 126 are advantageously used to communicate information to associated users and receive selections from such associated users.

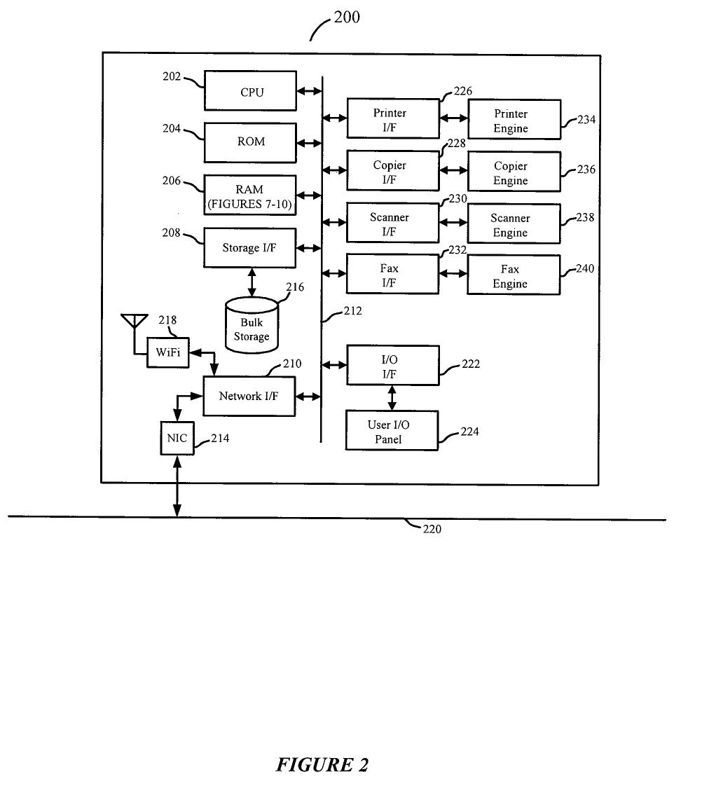

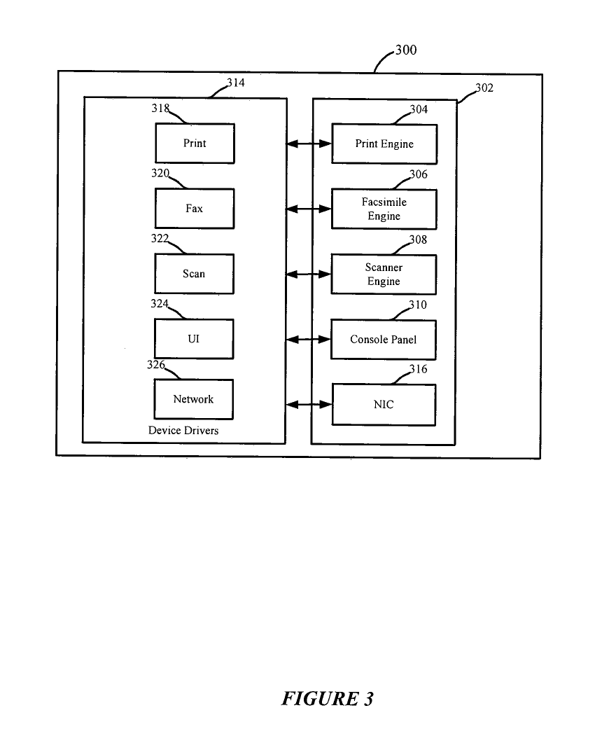

The skilled artisan will appreciate that the user interfaces 106, 116, and 126 comprise various components, suitably adapted to present data to associated users, as are known in the art. In accordance with one embodiment of the subject application, the user interfaces 106, 116, and 126 comprise a display, suitably adapted to display one or more graphical elements, text data, images, or the like, to an associated user, receive input from the associated user, and communicate the same to a backend component, such as controllers 108, 118, and 128, as explained in greater detail below. Preferably, the document rendering devices 104, 114, and 124 are communicatively coupled to the computer network 102 via suitable communications links 112, 122, and 132. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document rendering devices 104, 114, and 124 will be better understood in conjunction with the block diagrams illustrated in FIGS. 2 and 3, explained in greater detail below.

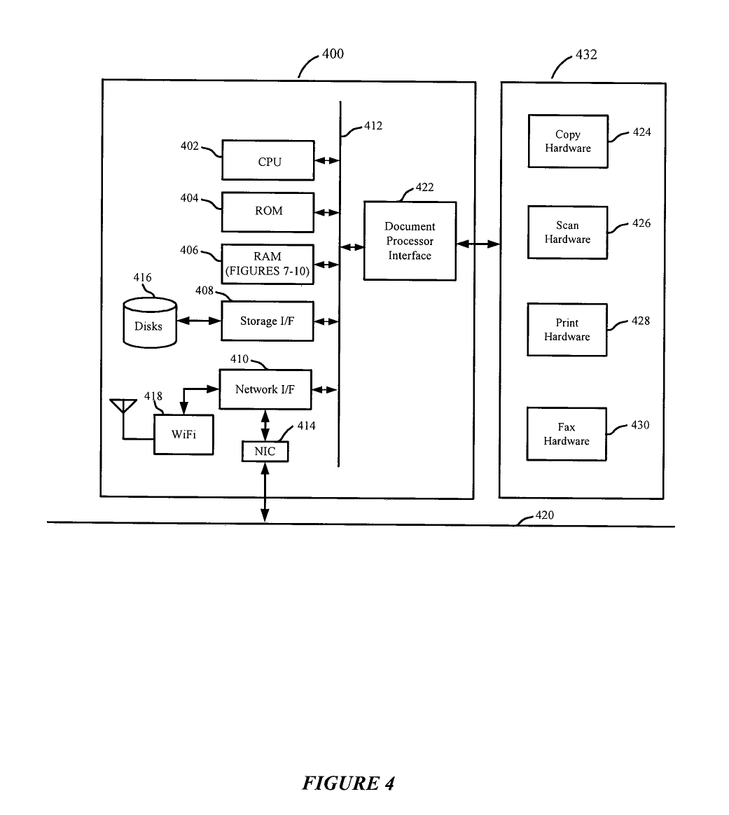

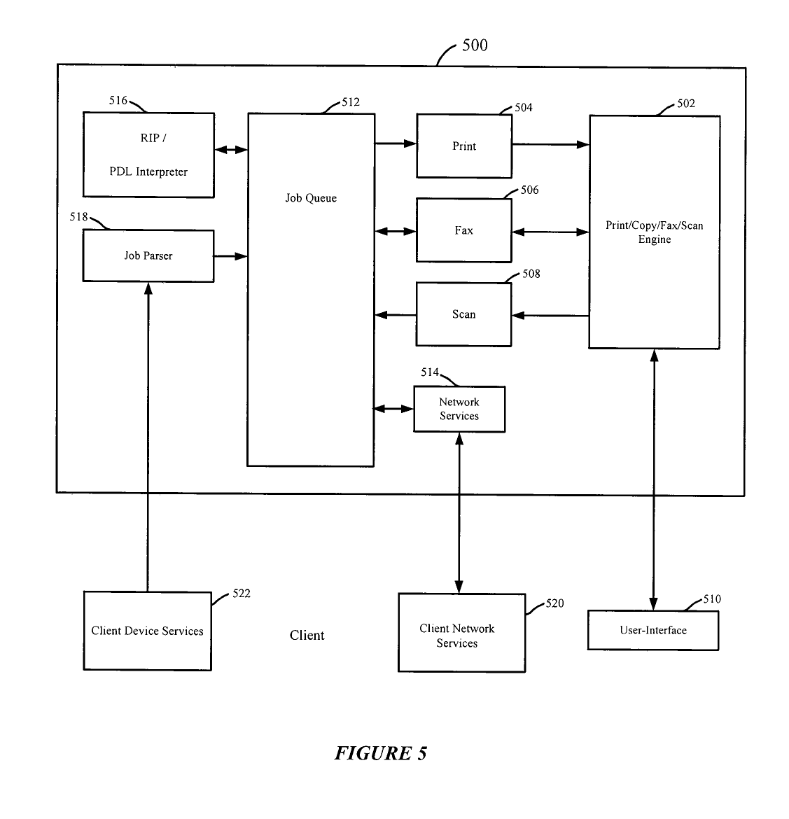

In accordance with one embodiment of the subject application, the document rendering devices 104, 114, and 124 further incorporate a backend component, designated as the controllers 108, 118, and 128, suitably adapted to facilitate the operations of their respective document rendering devices 104, 114, and 124, as will be understood by those skilled in the art. Preferably, the controllers 108, 118, and 128 are embodied as hardware, software, or any suitable combination thereof, configured to control the operations of the associated document rendering devices 104, 114, and 124, facilitate the display of images via the user interfaces 106, 116, and 126, direct the manipulation of electronic image data, maintain the security of applications, user information, data, and the like. For purposes of explanation, the controllers 108, 118, and 128 are used to refer to any myriad of components associated with the document rendering devices 104, 114, and 124, including hardware, software, or combinations thereof, functioning to perform, cause to be performed, control, or otherwise direct the methodologies described hereinafter. It will be understood by those skilled in the art that the methodologies described with respect to the controllers 108, 118, and 128 are capable of being performed by any general purpose computing system, known in the art, and thus the controllers 108, 118, and 128 are representative of such a general computing device and is intended as such when used hereinafter. Furthermore, the use of the controllers 108, 118, and 128 hereinafter is for the example embodiment only, and other embodiments, which will be apparent to one skilled in the art, are capable of employing the system and method for automated maintenance of preselected security levels for document processing devices of the subject application. The functioning of the controllers 108, 118, and 128 will better be understood in conjunction with the block diagrams illustrated in FIGS. 4 and 5, explained in greater detail below.

Communicatively coupled to the document rendering devices 104, 114, and 124 are data storage devices 110, 120, and 130. In accordance with the preferred embodiment of the subject application, the data storage devices 110, 120, and 130 are any mass storage device known in the art including, for example and without limitation, magnetic storage drives, a hard disk drive, optical storage devices, flash memory devices, or any suitable combination thereof. In the preferred embodiment, the data storage devices 110, 120, and 130 are suitably adapted to store security levels, security software, document data, image data, electronic database data, or the like. It will be appreciated by those skilled in the art that while illustrated in FIG. 1 as being a separate component of the system 100, the data storage devices 110, 120, and 130 are capable of being implemented as internal storage components of the document rendering devices 104, 114, and 124, components of the controllers 108, 118, and 128, or the like, such as, for example and without limitation, an internal hard disk drive, or the like.

Illustrated in FIG. 1 are a first kiosk 134, communicatively coupled to the first document rendering device 104, and in effect, the computer network 102, a second kiosk 142, communicatively coupled to the second document rendering device 114, and in effect, the computer network 102, a third kiosk 150 communicatively coupled to the third document rendering device 124, and in effect the computer network 102. It will be appreciated by those skilled in the art that the kiosks 134, 142, and 150 are capable of being implemented as separate component of the respective document rendering devices 104, 114, and 124, or as integral components thereof. Use of the kiosks 134, 142, and 150 in FIG. 1 are for example purposes only, and the skilled artisan will appreciate that the subject application is capable of implementation without the use of kiosks 134, 142, and 150; and the use of such kiosks 124, 142, and 150 is for one example embodiment only. In accordance with one embodiment of the subject application, the kiosks 134, 142, and 150 include respective displays 136, 144, and 152 and user input devices 138, 146, and 154. As will be understood by those skilled in the art the kiosks 134, 142, and 150 are capable of implementing a combination user input device/display, such as a touch screen interface. According to one embodiment of the subject application, the kiosks 134, 142, and 150 are suitably adapted to display selected advertisements to prospective customers, prompts to an associated user, receive instructions from the associated user, receive payment data, receive selection data from the associated user, and the like. Preferably, the kiosks 134, 142, and 150 include a magnetic card reader, conventional bar code reader, or the like, suitably adapted to receive and read payment data from a credit card, coupon, debit card, or the like.

The system 100 of FIG. 1 also includes portable storage device readers 140, 148, and 156, coupled to the kiosks 134, 142, and 150 and suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

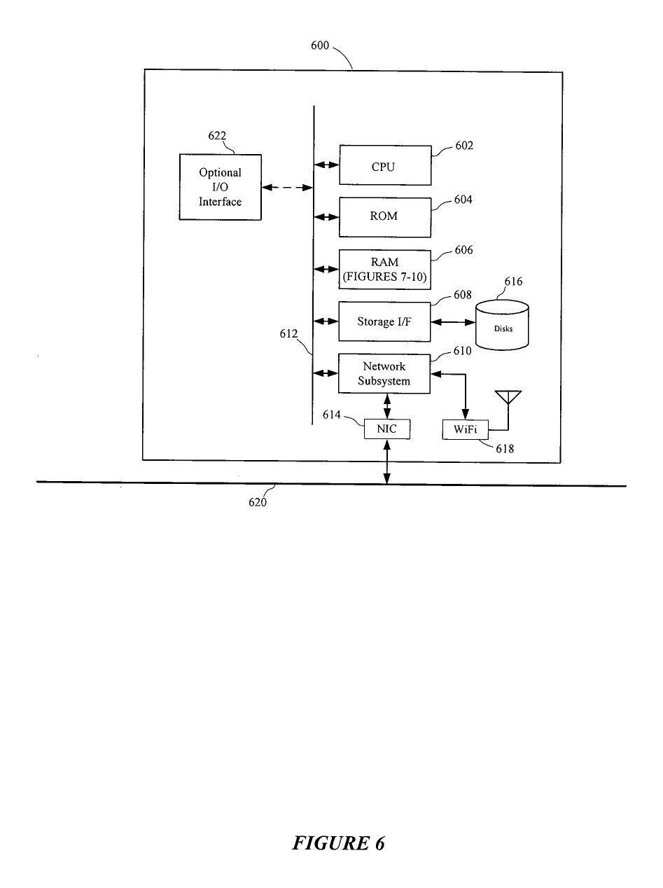

The system 100 illustrated in FIG. 1 further depicts a backend component, shown as the server 158, in data communication with the computer network 102 via a communications link 162. It will be appreciated by those skilled in the art that the server 158 is shown in FIG. 1 as a component of the system 100 for example purposes only, and the subject application is capable of implementation without the use of a separate backend server component, e.g. the server 158 is capable of implementation via one of the document processing devices 104, 114, or 124, or via an administrative device 164. The skilled artisan will appreciate that the server 158 comprises hardware, software, and combinations thereof suitably adapted to provide one or more services, web-based applications, storage options, and the like, to networked devices. In accordance with one example embodiment of the subject application, the server 158 includes various components, implemented as hardware, software, or a combination thereof, for managing retention of secured documents, text data, performing searches, comparisons, maintaining database entries, account information, receiving payment data, retrieval of documents, and the like, which are accessed via the computer network 102. The communications link 162 is any suitable data communications means known in the art including, but not limited to wireless communications comprising, for example and without limitation Bluetooth, WiMax, 802.11a, 802.11b, 802.11g, 802.11(x), a proprietary communications network, infrared, the public switched telephone network, optical, or any suitable wireless data transmission system, or wired communications known in the art. It will further be appreciated by those skilled in the art that the components described with respect to the server 158 are capable of implementation on any suitable computing device coupled to the computer network 102, e.g. the controllers 108, 118, 128, or the like. The functioning of the server 158 will better be understood in conjunction with the block diagram illustrated in FIG. 6, explained in greater detail below.

Communicatively coupled to the server 158 is the data storage device 160. According to the foregoing example embodiment, the data storage device 160 is any mass storage device, or plurality of such devices, known in the art including, for example and without limitation, magnetic storage drives, a hard disk drive, optical storage devices, flash memory devices, or any suitable combination thereof. In such an embodiment, the data storage device 160 is suitably adapted to store testing software, update software, document processing device identification data, document processing device security level data, account information, policy information, and the like. It will be appreciated by those skilled in the art that while illustrated in FIG. 1 as being a separate component of the system 100, the data storage device 160 is capable of being implemented as an internal storage component of the server 158, or the like, such as, for example and without limitation, an internal hard disk drive, or the like.

Also depicted in FIG. 1 is an administrative device, illustrated as an administrative computer workstation 164 in data communication with the computer network 102 via a communications link 166. It will be appreciated by those skilled in the art that the administrative workstation 164 is shown in FIG. 1 as a workstation computer for illustration purposes only. As will be understood by those skilled in the art, the administrative workstation 164 is representative of any personal computing device known in the art including, for example and without limitation, a laptop computer, a personal computer, a personal data assistant, a web-enabled cellular telephone, a smart phone, a proprietary network device, or other web-enabled electronic device. According to one embodiment of the subject application, the administrative workstation 164 further includes software, hardware, or a suitable combination thereof configured to interact with the document rendering devices 104, 114, and 124, communicate with the server 158, or the like.

The communications link 166 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the administrative workstation 164 is suitably adapted to provide document data, job data, user interface data, image data, monitor document processing jobs, employ thin-client interfaces, generate display data, generate output data, or the like, with respect to the document processing devices 104, 114, or 124, or any other similar device coupled to the computer network 102.

Turning now to FIG. 2, illustrated is a representative architecture of a suitable device 200, shown in FIG. 1 as the document rendering devices 104, 114, and 124, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document rendering devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document rendering device, depicted in FIG. 1 as the document rendering devices 104, 114, and 124, for use in connection with the disclosed system. FIG. 3 illustrates suitable functionality of the hardware of FIG. 2 in connection with software and operating system functionality as will be appreciated by one of ordinary skill in the art. The document rendering device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controllers 108, 118, and 128, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document rendering device 104, which includes the controller 400 of FIG. 4, (shown in FIG. 1 as the controllers 108, 118, and 128) as an intelligent subsystem associated with a document rendering device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a representative architecture of a suitable server 600 (depicted in FIG. 1 as the server 158), on which operations of the subject system are completed. Included is a processor 602, suitably comprised of a central processor unit. However, it will be appreciated that processor 602 may advantageously be composed of multiple processors working in concert with one another as will be appreciated by one of ordinary skill in the art. Also included is a non-volatile or read only memory 604 which is advantageously used for static or fixed data or instructions, such as BIOS functions, system functions, system configuration, and other routines or data used for operation of the server 600.

Also included in the server 600 is random access memory 606, suitably formed of dynamic random access memory, static random access memory, or any other suitable, addressable memory system. Random access memory provides a storage area for data instructions associated with applications and data handling accomplished by the processor 602.

A storage interface 608 suitably provides a mechanism for volatile, bulk or long term storage of data associated with the server 600. The storage interface 608 suitably uses bulk storage, such as any suitable addressable or serial storage, such as a disk, optical, tape drive and the like as shown as 616, as well as any suitable storage medium as will be appreciated by one of ordinary skill in the art.

A network interface subsystem 610 suitably routes input and output from an associated network allowing the server 600 to communicate to other devices. The network interface subsystem 610 suitably interfaces with one or more connections with external devices to the server 600. By way of example, illustrated is at least one network interface card 614 for data communication with fixed or wired networks, such as Ethernet, token ring, and the like, and a wireless interface 618, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 614 is interconnected for data interchange via a physical network 620, suitably comprised of a local area network, wide area network, or a combination thereof.

Data communication between the processor 602, read only memory 604, random access memory 606, storage interface 608 and the network subsystem 610 is suitably accomplished via a bus data transfer mechanism, such as illustrated by bus 612.

Suitable executable instructions on the server 600 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 622 as will be appreciated by one of ordinary skill in the art.

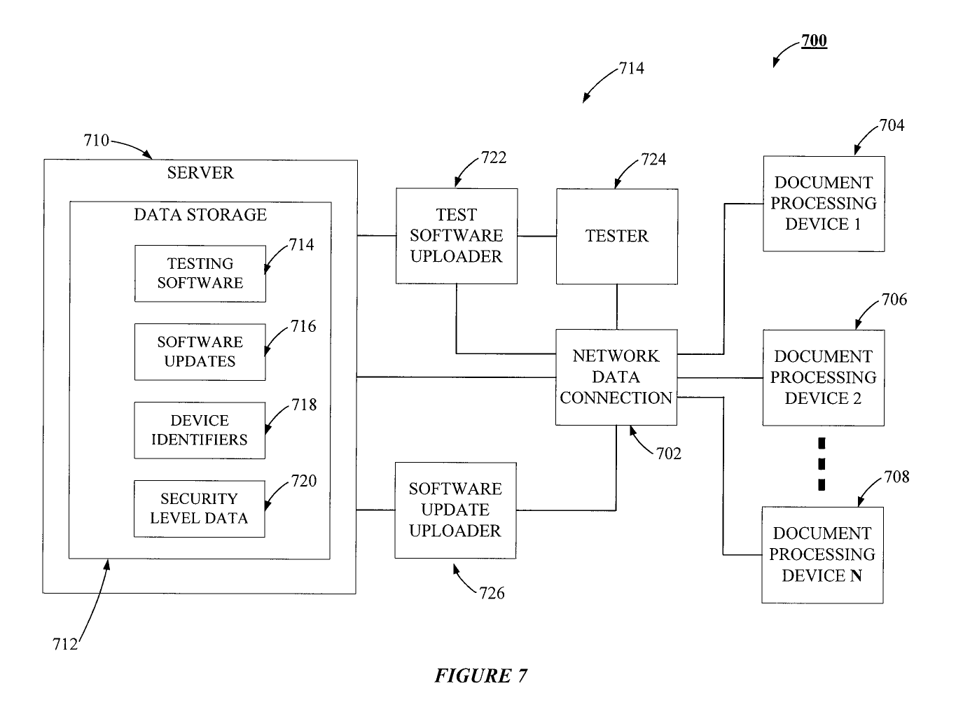

Referring now to FIG. 7, illustrated is a block diagram of a system 700 for automated maintenance of preselected security levels for document processing devices in accordance with one embodiment of the subject application. As shown in FIG. 7, the system 700 includes a network data connection 702 in data communication with multiple document processing devices 704, 706, and 708. The system 700 also includes a server 710 equipped with a server data storage 712.

In accordance with one embodiment of the subject application, the server data storage 712 includes testing software 714 configured for testing for at least one vulnerability when running on at least one of the document processing devices 704, 706, and 708. The server data storage 712 also stores software updates 716 for the software resident on the document processing devices 704, 706, and 708. In addition, the storage 712 includes device identifiers 718 and security level data 720. According to one embodiment of the subject application, each identifier 718 is associated with a specific document processing device 704, 706, and 708. The security level data 720 includes a security level corresponding to each identifier 718.

The system 700 also includes a test software uploader 722 that is configured to push the testing software 714 to the document processing device 704, 706, or 708 via the network data connection 702 in accordance with the associated device identifier 718. The system further comprises a tester 724 suitably configured to receive test result data corresponding to a running of the pushed testing software 714 on the document processing device 704, 706, or 708 being tested. Thereafter, a software update uploader 726 of the system 700 is included to push at least one device software update 716 to the document processing device 704, 706, or 708 based upon the received test result data via the tester 724 and security level data 720 corresponding to the document processing device 704, 706, or 708.

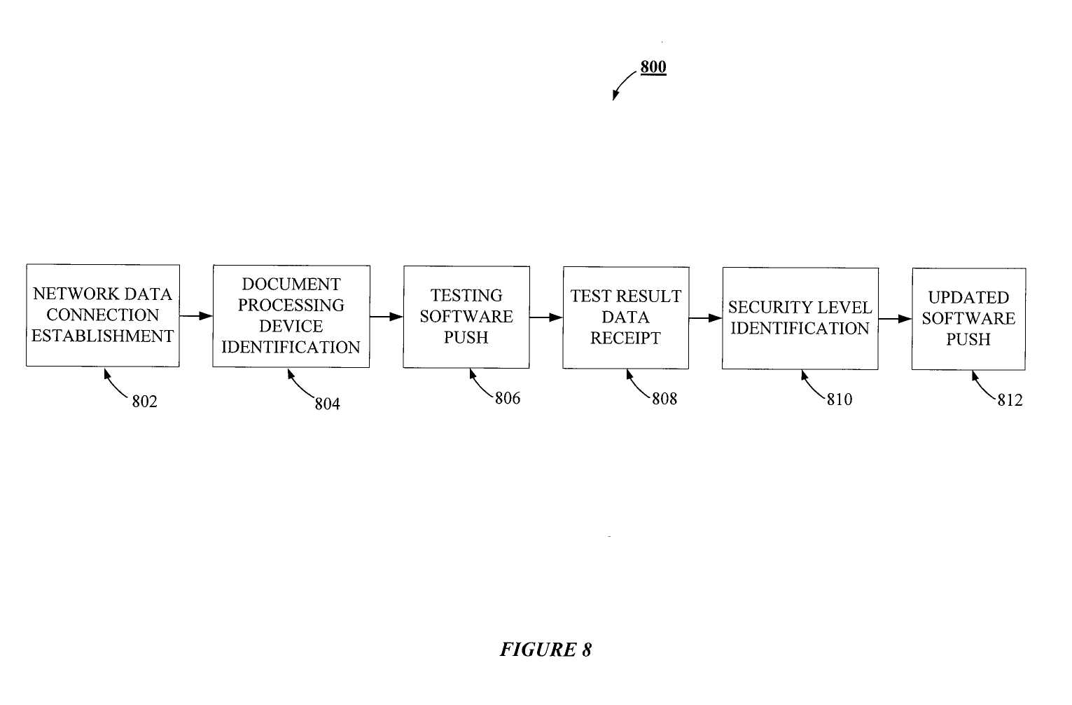

Turning now to FIG. 8, illustrated is a functional diagram of a system 800 for automated maintenance of preselected security levels for document processing devices in accordance with one embodiment of the subject application. As shown in FIG. 8, network data connection establishment 802 first occurs with at least one document processing device of multiple such devices. Document processing device identification 804 is then performed identifying the document processing device via which a connection has been established at 802. Testing software push 806 then occurs resulting in a push of testing software to the document processing device so as to commence loading and running of the software by the device. Test result data receipt 808 then occurs of data resulting from the document processing device based upon a running of the testing software. Security level identification 810 is then performed so as to identify a security level associated with the document processing device. Updated software push 812 is then performed, resulting in the pushing of updated software to the document processing device in accordance with the received testing results and an identified security level.

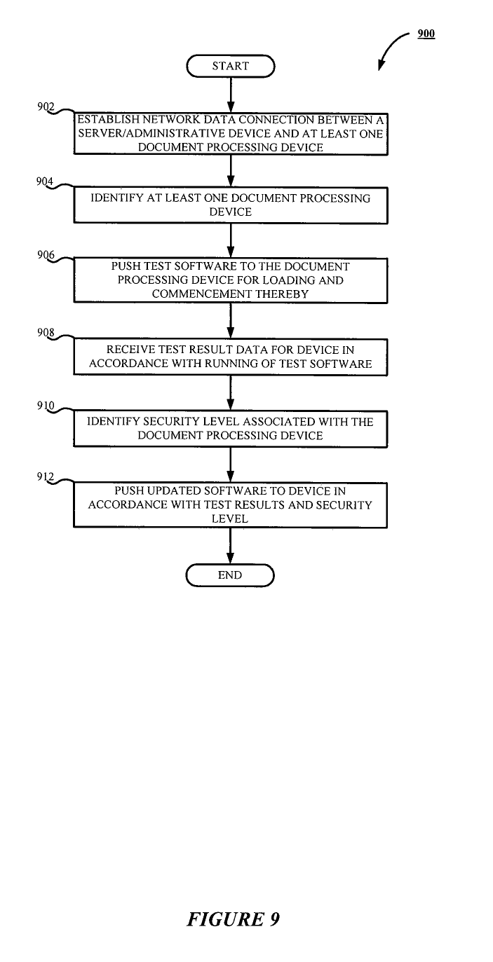

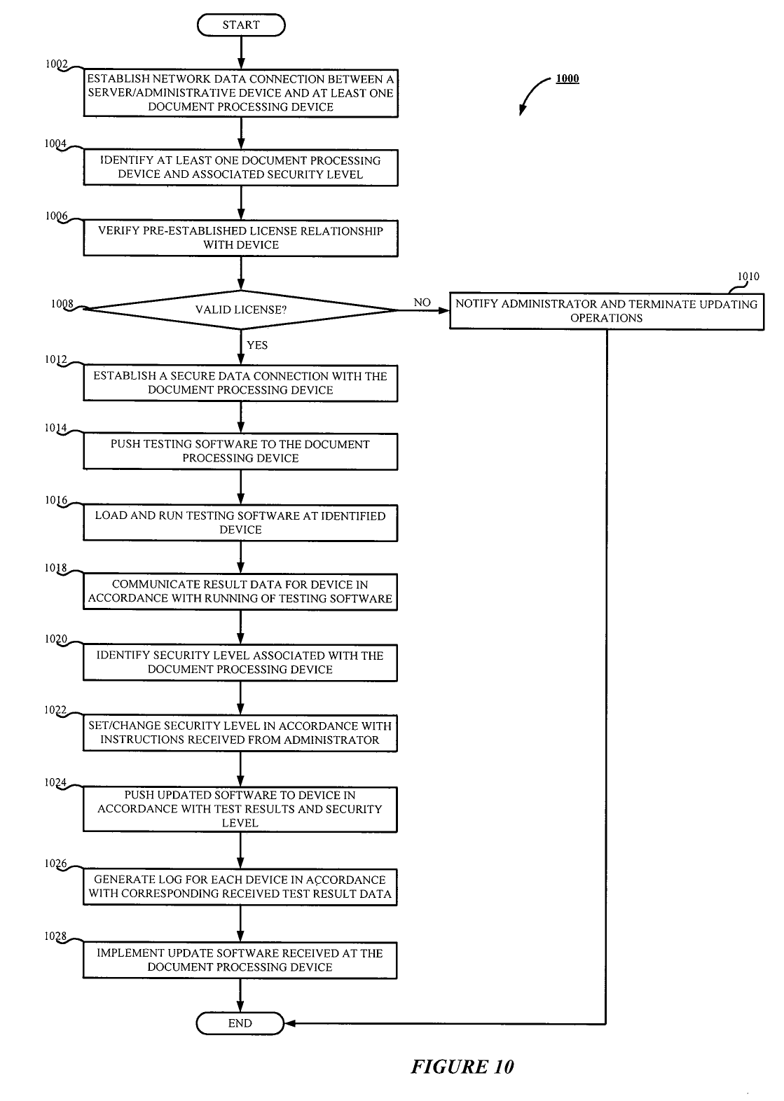

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10. Turning now to FIG. 9, there is shown a flowchart 900 illustrating an automated maintenance of preselected security levels for document processing devices method in accordance with one embodiment of the subject application. Beginning at step 902, a network data connection is established between a server 158 or administrative device 164 and at least one document processing device 104, 114, or 124 from among those present on the computer network 102. It will be appreciated by those skilled in the art that such a connection is capable of establishment between either the administrative device 164 or the server 158 with the document processing device 104, 114, or 124.

At step 904, at least one of the document processing devices 104, 114, or 124 is identified from among those which have an established network data connection. Testing software is then pushed to the at least one document processing device 104, 114, or 124 at step 906. Preferably, the receiving document processing device 104, 114, or 124 then commences the loading and running of the testing software. At step 908, the server 158 or administrative device 164 receives test result data for the document processing device 104, 114, or 124 in accordance with the running of the testing software. A security level associated with the document processing device 104, 114, or 124 is then identified by the server 158 or administrative device 164 at step 910. Updated software is then pushed at step 912 to the document processing device 104, 114, or 124 based upon the received test result data and the identified security level.

Referring now to FIG. 10, there is shown a flowchart 1000 illustrating a method for automated maintenance of preselected security levels for document processing devices in accordance with one embodiment of the subject application. The methodology of FIG. 10 begins at step 1002, whereupon a network data connection is established between at least one of the document processing devices 104, 114, and 124, and the server 158, the administrative device 164, or the like. It will be appreciated by those skilled in the art that such a connection is capable of being established via suitable protocols over the computer network 102. At least one of the document processing devices 104, 114, and 124 that has an established connection is then identified by the server 158 or administrative device 164 at step 1004. In accordance with one embodiment of the subject application, such identification is capable of being accomplished using a device name, IP address, MAC address, administrative designation, model number, or the like. Preferably, a security service, e.g. application, daemon, process, or the like, resident on the controller 108, 118, or 128, or other suitable component associated with the document processing device 104, 114, or 124 is suitably configured to establish such a connection and provide identification data, inclusive of a security level associated with the device 104, 114, or 124, to the server 158 or administrative device 164. In one example embodiment of the subject application, the security service resident on the document processing device 104, 114, and 124 is configured to perform scans and remediation with respect to the security of the device 104, 114, and 124.

At step 1006, the server 158 or administrative device 164 attempts to verify a pre-established license relationship with the identified device 104, 114, or 124. It will be appreciated by those skilled in the art that such verification is capable of corresponding to an ongoing service plan, a warranty, standard updates, vendor-specific maintenance, and the like. A determination is then made at step 1008 whether a valid license was verified at step 1006. That is, the server 158 or administrative device 164 determines with the identified document processing device 104, 114, or 124 has a valid license for software updates, support, maintenance, or the like. Upon a determination that a valid license associated with the device 104, 114, or 124 is not found, flow proceeds to step 1010. At step 1010, the administrator 164 is suitably notified of the failed license verification and operations with respect to FIG. 10 terminate associated with the identified document processing device 104, 114, or 124.

Upon a determination at step 1008 that a valid license exists corresponding to the identified document processing device 104, 114, or 124, operations proceed to step 1012. At step 1012, the server 158 and the identified document processing device 104, 114, or 124 establish a secure data connection. It will be appreciated by those skilled in the art that such secure connection is capable of being accomplished via the computer network 102, using any suitable security protocols known in the art. At step 1014, the server 1014 pushes testing software to the identified document processing device 104, 114, or 124. In accordance with one embodiment of the subject application, the server 158 stores a plurality of vulnerability testing programs, security testing programs, and the like. It will be understood by those skilled in the art that while reference is made to the server 158 performing the steps described hereinafter, the administrative device 164 is also capable of being employed in accordance with the subject application. According to one embodiment of the subject application, the testing software communicated to the identified document processing device 104, 114, or 124 is in an XML format, in accordance with the identification data and security level communicated therefrom, as will be appreciated by those skilled in the art.

At step 1016, the testing software is loaded and run via controller 108, 118, or 128 on the associated with the identified document processing device 104, 114, or 124. In accordance with one embodiment of the subject application, the security service associated with the controller 108, 118, or 128 runs the testing software so as to determine vulnerabilities in the security of the associated document processing device 104, 114, or 124. At step 1018, the controller 108, 118, 128, or other suitable component associated with the document processing device 104, 114, or 124 communicates testing result data to the server 158 in accordance with the running of the testing software. The server 158 then identifies a security level associated with the reporting device 104, 114, or 124 at step 1020 so as to determine appropriate update or patch software for the identified device 104, 114, or 124. At step 1022, the administrator, via interactions at the server 158 or administrative device 164, sets the security level for the document processing device 104, 114, or 124. The skilled artisan will appreciate that the subject application is capable of implementation such that step 1022 is bypassed when no changes to the identified security level are desired by the associated administrator.

Suitable update or patch software is then pushed, via the computer network 102, from the server 158 to the document processing device 104, 114, or 124 at step 1024. In accordance with one embodiment of the subject application, the update software is communicated using an XML format to the security service resident on the receiving document processing device 104, 114, or 124. At step 1026, the server 158 generates a log corresponding to the update software, detected vulnerabilities, remediation information, and the like. Preferably, the log is stored on the associated data storage device 160 in accordance with each individual document processing device 104, 114, and 124 that is updated in accordance with the methodology of FIG. 10. Thereafter, the security service of the controller 108, 118, or 128 associated with the receiving document processing device 104, 114, or 124, then implements the update software received from the server 158 at step 1028.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for automated maintenance of preselected security levels for document processing devices comprising:
a network data connection with a plurality of document processing devices;
a server data storage including;
testing software operable to test at for at least one vulnerability when running on at least one of the document processing devices,
document processing device software updates,
an identifier associated with each of the document processing devices, and
security level data corresponding to each identifier;
a test software uploader operable to push the testing software to the at least one document processing device via the network data connection;
a tester operable to receive test result data corresponding to a running of the pushed testing software on the at least one document processing device; and
a software update uploader operable to push at least one device software update to the at least one document processing device in accordance with received test result data and security level data corresponding to the at least one document processing device.

2. The system of claim 1 further comprising:
a login data input operable to receive login data from the at least one document processing device via the network data connection;
a login table inclusive of data corresponding to document processing devices preauthorized for security analysis;
a comparator operable to compare received login data with data of the login table; and wherein
the test software uploader is operable in accordance with an output of the comparator.

3. The system of claim 2 wherein the test result data includes data corresponding to a version of software currently operable on the at least one document processing device.

4. The system of claim 3 wherein the server data storage further includes log data corresponding to software versions currently operable on the plurality of document processing devices.

5. The system of claim 3 wherein the network data connection is secured to the at least one document processing device.

6. A method for automated maintenance of preselected security levels for document processing devices comprising the steps of:
establishing a network data connection with at least one document processing device of a plurality thereof;
identifying at least one document processing device;
pushing testing software to the at least one document processing device so as to commence loading and running thereof;
receiving test result data from the at least one document processing device in accordance with a running of the testing software;
identifying a security level associated with the at least one document processing device; and
pushing updated software to the at least one document processing device in accordance with received test result data and an identified security level.

7. The method of claim 7 further comprising the step of generating a log in accordance with each of the plurality of document processing devices in accordance with result data received therefrom.

8. The method of claim 7 further comprising the step of establishing a secure data connection with the at least one document processing device.

9. The method of claim 7 further comprising the step of verifying a pre-established license relationship with the at least one document processing device prior to pushing of the testing software thereto.

10. The method of claim 7 further comprising the step of setting the security level in accordance with instructions received from an associated administrator.

11. A system for automated maintenance of preselected security levels for document processing devices comprising:
means adapted for establishing a network data connection with at least one document processing device of a plurality thereof;
means adapted for identifying at least one document processing device;
means adapted for pushing testing software to the at least one document processing device so as to commence loading and running thereof;
means adapted for receiving test result data from the at least one document processing device in accordance with a running of the testing software;
means adapted for identifying a security level associated with the at least one document processing device; and
means adapted for pushing updated software to the at least one document processing device in accordance with received test result data and an identified security level.

12. The system of claim 11 further comprising means adapted for generating a log in accordance with each of the plurality of document processing devices in accordance with result data received therefrom.

13. The system of claim 12 further comprising means adapted for establishing a secure data connection with the at least one document processing device.

14. The system of claim 12 further comprising means adapted for verifying a pre-established license relationship with the at least one document processing device prior to pushing of the testing software thereto.

15. The system of claim 2 further comprising means adapted for setting the security level in accordance with instructions received from an associated administrator.
